(19) United States
(12) Patent Application Publication
(10) Pub. No.: US 2015/0112753 A1
(43) Pub. Date: Apr. 23, 2015

(54) SOCIAL CONTENT FILTER TO ENHANCE SENTIMENT ANALYSIS

(71) Applicant: Adobe Systems Incorporated, San Jose, CA (US)

(72) Inventor: Harish K. Suvarna, San Jose, CA (US)

(73) Assignee: Adobe Systems Incorporated, San Jose, CA (US)

(21) Appl. No.: 14/056,246

(22) Filed: Oct. 17, 2013

(51) Int. Cl. G06Q 30/02; G06Q 50/00

(52) U.S. Cl. CPC G06Q 30/0201; G06Q 50/01
USPC 705/7.29

(57) ABSTRACT

Techniques are disclosed for filtering and analyzing social network content so that consumer sentiment can be gauged more accurately and efficiently. In certain embodiments social network content can be filtered so that individual content items can be identified as comprising neutral, sentiment bearing, spam or foreign language content. Such filtering can be performed by marking certain features that are indicative of a particular type of content, and then using machine learning systems to classify individual content items based on the marked features. A portion of the filtered content, such as only the items containing sentiment bearing content, can then be subjected to sentiment analysis. The results of this sentiment analysis can be presented to a social network campaign manager via a sentiment browser interface, optionally with the underlying filtered content. This allows the campaign manager to easily view the results of the sentiment analysis with the filtered social network content.

### FIELD OF THE DISCLOSURE

This disclosure relates generally to the evaluation of content generated via social networks, and more specifically to methods for filtering and analyzing social network content so that consumer sentiment can be gauged more accurately and efficiently.

### BACKGROUND

As the number of people with access to the Internet continues to steadily increase, a correspondingly large number of applications have been developed that facilitate interaction amongst Internet users. One class of such applications, referred to as social network applications, allows people to establish relationships and interact with each other in an online environment. In particular, social network applications allow users to build a personal profile and establish groups of users who share common interests, backgrounds or real-life connections. Social network applications facilitate interaction amongst their various members by providing tools that make it easy to chat, share pictures, post updates and broadcast announcements to other members of the network. The social networks that are generated through the use of such applications have grown to be particularly important to marketers, and consequently, social network applications now play an important role in many modern marketing campaigns. For example, it is not uncommon for marketers to make announcements, run promotions and interact with consumers using such applications.

### BRIEF DESCRIPTION OF THE DRAWINGS

FIG. 1A is a block diagram illustrating selected components of a system that allows social network content to be filtered and analyzed in accordance with an embodiment of the present invention.

FIG. 1B is a block diagram illustrating selected subcomponents of the content filter of FIG. 1A, as configured in accordance with an embodiment of the present invention.

FIG. 2A is a block diagram illustrating data flow amongst selected components of the system of FIG. 1A, wherein social network content is filtered before being subjected to sentiment analysis, as performed in accordance with an embodiment of the present invention.

FIG. 2B is a flowchart illustrating a method for filtering and analyzing social network content using the data flow of FIG. 2A in accordance with an embodiment of the present invention.

FIG. 3A is a block diagram illustrating data flow amongst selected components of the system of FIG. 1A, wherein social network content is not filtered before being subjected to sentiment analysis, as performed in accordance with an embodiment of the present invention.

FIG. 3B is a flowchart illustrating a method for filtering and analyzing social network content using the data flow of FIG. 3A in accordance with an embodiment of the present invention.

FIG. 4 is a flowchart illustrating a method for characterizing social network content as being neutral, sentiment bearing, spam or foreign language content in accordance with an embodiment of the present invention.

FIGS. 5A through 5C form a flowchart illustrating a method for marking features indicative of spam content and/or sentiment-bearing content in accordance with an embodiment of the present invention.

FIG. 6 is a flowchart illustrating a method for marking features associated with foreign language social network content in accordance with an embodiment of the present invention.

FIG. 7 is a flowchart illustrating a method for classifying social network content as being neutral, sentiment bearing, spam or foreign language content based on the feature-marking methodologies illustrated in FIGS. 5A through 5C and FIG. 6, in accordance with an embodiment of the present invention.

### DETAILED DESCRIPTION

Social networks, such as Facebook or Twitter, are particularly important to marketers and advertising entities, and as a result, such networks frequently play an important role in modern marketing campaigns. Indeed, marketers often devote substantial resources to influencing and monitoring consumer sentiment across social networks. However, monitoring of social network sentiment can be a complex, subjective and time-consuming process. While a simple approach to sentiment evaluation might involve providing bulk unfiltered content to a sentiment analysis service, there can be significant downsides to such an approach. For example, social network content often contains large amounts of less significant or completely irrelevant data such as foreign language content, bulk advertising messages and profanity. If a marketer or campaign manager wishes to evaluate the meaning of sentiment contained within social network content, it will be desirable to remove content which does not contain sentiment. Indeed, there are several advantages associated with filtering social network content before undertaking sentiment analysis. For example, sentiment analysis providers often charge for their services based on the quantity of data analyzed, for example by charging a fee per megabyte of analyzed data, and therefore filtering the social network content before submitting it to an analysis provider can reduce costs. In addition, submitting large quantities of data for sentiment analysis not only requires significant bandwidth, which itself can be expensive, but also causes such services to respond to analysis requests more slowly. This is because sentiment analysis engines invoke natural language processing components which can be highly computationally intensive. Moreover, analyzing data that is irrelevant to the sentiment analysis—such as spam content or unintelligible foreign language content—may cause the analysis results to be skewed since the underlying data set will appear to contain a disproportionately large amount of content having neutral or ambiguous sentiment. Therefore reducing the overall quantity of data submitted for sentiment analysis—and in particular, avoiding needless analysis of spam and foreign language content—will reduce analysis costs, enable analysis to be provided in a more responsive fashion, and produce a more accurate and relevant analysis results.

Thus, and in accordance with an embodiment of the present invention, techniques are provided herein for filtering and analyzing social network content in a way that allows consumer sentiment to be gauged more accurately and efficiently. For example, in one embodiment a content filter is provided that is capable of analyzing social network content and making predictions with respect to whether individual content items comprise neutral, sentiment bearing, spam or foreign language content. This facilities removal of content that does not contain sentiment before undertaking sentiment analysis. Because the results of sentiment analysis are often presented to a social network campaign manager in conjunction with the underlying filtered content itself, the content filtration techniques disclosed herein can also be used to avoid presenting the campaign manager with raw data that is not of interest. Thus the various embodiments of the content filter disclosed herein can be used to make the sentiment analysis process more efficient and effective by reducing the amount of data that is subjected to sentiment analysis, either through the removal of uninteresting content (for example, in the case of spam content), or through the diversion of certain content to a more appropriate sentiment analysis engine (for example, in the case of foreign language content). The various embodiments of the content filter disclosed herein can also be used to make the sentiment analysis process more accurate by removing spam and foreign language content which tends to cause the analyzed content to appear more neutral or ambiguous than it actually is. In addition, the various embodiments disclosed herein can also be used to generate a more accurately focused filtered set of social network data for review by a campaign manager or other end user.

Another challenge that arises in the context of filtering of social network content derives from the fact that spammers often change their terminology, social users have a continually evolving vocabulary used to express profanity, and new users periodically post content using new languages and/or dialects. Thus distinguishing sentiment-bearing content from spam and/or foreign language content is a non-trivial process that involves ongoing adjustments to the content filter to dynamically respond to the continually changing nature of social network data. Existing filtering technologies are not well-suited for responding to such changes and lack the ability to dynamically change how the filter works. To address these challenges, certain embodiments of the present invention use two different machine learning systems that work together to allow individual content items to be characterized with improved accuracy. For example, a naïve Bayes classifier can be initially trained to consider a plurality of content features to determine which are indicative of certain content types. Once such features are marked or “tagged” with respect to a particular content item, a support vector machine (SVM) learning model can be used to make predictions with respect to how individual content items are best characterized based on the marked features in each content item. Content filters configured in this way have been able to characterize social network content with significantly higher accuracy than has been achieved using conventional filtration techniques based on, for example, a bag-of-words model.

For instance, if a statistically significant portion of the marked features contained within a particular content item are associated with sentiment bearing content, then the content item can be characterized as sentiment bearing and can be processed accordingly. Examples of features associated with sentiment bearing content are sentiment words such as “excellent”, “terrible”, “spectacular” and “horrendous”. Likewise, if a statistically significant portion of the marked features contained within the content item are associated with spam content, then the content item can be characterized as spam and processed accordingly. Examples of features associated with spam content include the presence of spam phrases such as “earn more”, spam patterns such as “50% off”, currency patterns such as “$9.99”, and the absence of certain predefined topics of interest. Where a variety of different features are marked such that no conclusion can be drawn with respect to the nature of the content item, then the content can be characterized as ambiguous or content neutral. The proportion of ambiguous content can be manipulated and the content filter can be selectively biased by masking certain features. For example, a bias toward detection of sentiment bearing content can be achieved by masking features associated with spam content. Similarly, a bias toward removal of irrelevant data can be achieved by masking features associated with sentiment bearing content.

As used herein, the term “social network content” refers, in addition to its ordinary meaning, to content generated, shared and/or otherwise transmitted using any of a variety of computer-based tools intended to facilitate interaction amongst computer users. Such tools may include applications, utilities and other online platforms provided by, for example, blogging services, micro-blogging services, text messaging services, instant messaging services, or any other appropriate social network services. Thus, for example, in certain embodiments social network content may include tweets broadcast by users of the Twitter social network service (Twitter Inc., San Francisco, Calif.), status updates posted by users of the Facebook social network service (Facebook Inc., Menlo Park, Calif.), postings generated by users of the Google+ social network service (Google Inc., Mountain View, Calif.), and/or blog entries submitted by users of the Tumblr micro-blogging platform (Yahoo! Inc., Sunnyvale, Calif.). Social network content may include a wide variety of data, including but not limited to text, network addresses and multimedia assets. Social network content may also include metadata corresponding to user activity, such as data indicating that a user has indicated that he or she “likes” or is otherwise positively disposed toward something that has been seen or experienced in either an online or offline context. Another example of such metadata is “check-in” or similar data indicating that a particular user is physically present at a particular location, such as at a retail establishment or a shopping mall. Such metadata may also include data indicative of a user's interests, followers, friends, browsing patters and the like. In certain embodiments social network content may be automatically or semi-automatically generated based on a script, applet or other control feature. Social network content may also sometimes be referred to as “social media”.

As used herein, “sentiment bearing content” is content from which sentiment—either positive or negative—can be inferred. Examples of sentiment bearing content may include a post observing that a particular department store is having a spectacular sale, or a tweet opining that a particular airline has terrible customer service. In many cases, it is impossible to reliably infer any particular sentiment from a given content item, in which case the content item may be characterized as comprising “neutral content”. Examples of neutral content may include a post announcing a person's location or a tweet reporting the opening hours of a particular grocery store. Neutral content should be distinguished from “spam content”, which refers, in addition to its ordinary meaning, to content broadcast indiscriminately to a large number of users. Spam content often, though not necessarily, comprises advertising that is sent on an unsolicited basis; it is usually considered by recipients to be irrelevant, inappropriate, unwanted or otherwise intrusive. Spam content may be irrelevant in the sense of relating to a topic that is not of interest to a particular user, even if that topic may be of great interest to other users. For example, a message relating to the halftime show at a major sporting event may be considered spam by a user who is only interested in the players participating in the sporting game itself. Neutral content should also be distinguished from foreign language content; foreign language content may contain sentiment, although such sentiment not be analyzable depending on the particular sentiment analysis resources available in a given application.

System Architecture

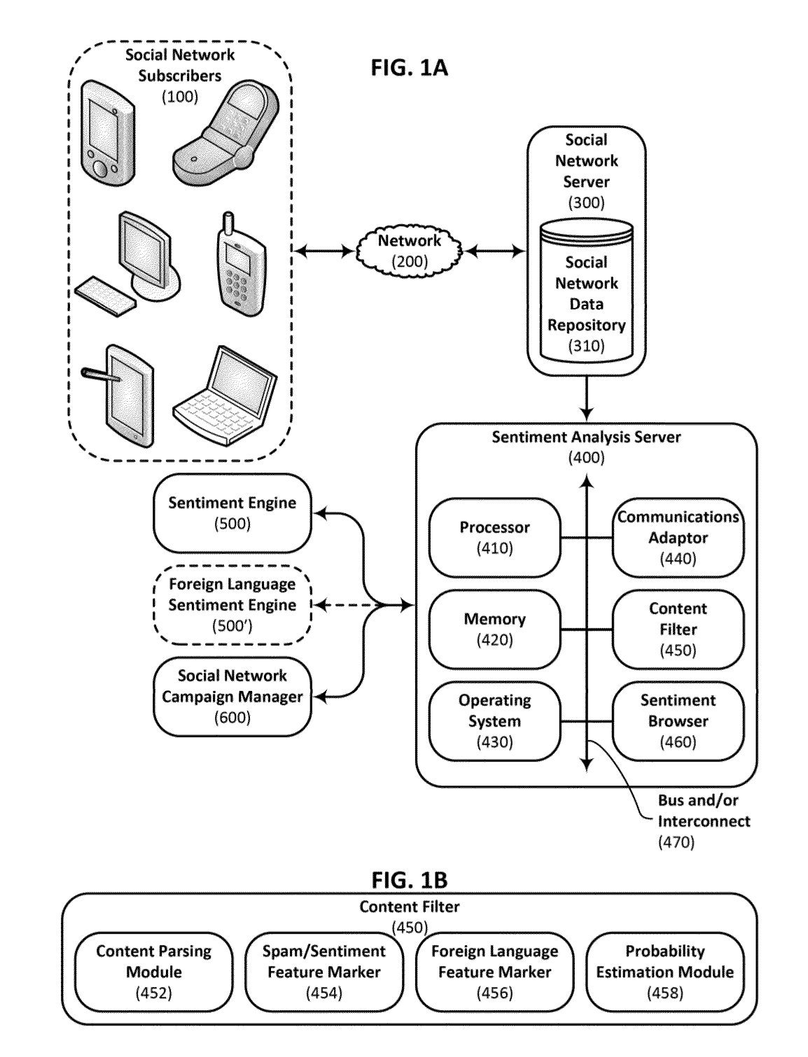

FIG. 1A is a block diagram illustrating selected components of a system that allows social network content to be filtered and analyzed in accordance with an example embodiment of the present invention. As illustrated, a plurality of social network subscribers 100 interact with a social network server 300 via a network 200. Social network subscribers 100 may use any of a variety of suitable computing devices for such interaction, including devices such as handheld computers, cellular telephones, tablet computers, smartphones, laptop computers, desktop computers and set-top boxes. Other devices may be used in other embodiments. Network 200 may be a local area network (such as a home-based or office network), a wide area network (such as the Internet), or a combination of such networks, whether public, private or both. Communications amongst social network subscribers 100, network 200 and social network server 300 may occur via wired and/or wireless connections, such as may be provided by Wi-Fi or mobile data networks. In some cases access to resources on a given network or computing system may require credentials such as usernames, passwords and/or any other suitable security mechanism. While only six social network subscribers 100 and one social network server 300 are illustrated in the example embodiment of FIG. 1A, it will be appreciated that, in general, the system may comprise a distributed network of tens, hundreds, thousands or more social network servers 300 capable of interacting with an even larger number of social network subscribers 100. In such case, each of the social network servers may be dedicated to providing a particular type of social network service, such that, for example, certain servers are dedicated to providing text messaging services (such as Twitter), while other servers are dedicated to providing micro-blogging services (such as Tumblr). In other cases, a single social network server can be configured to provide a variety of different social network services.

Social network server 300 is configured to manage the transmission of data and services to, and the reception of data and resource requests from, social network subscribers 100. In certain embodiments social network server 300 provides services such as those typically associated with social network services like Facebook, Google+ and Twitter. For example, in an embodiment wherein social network server 300 provides text messaging services, social network subscribers 100 may send and receive text messages through social network server 300. Social network postings, data and other input received from social network subscribers 100 can be stored in a social network data repository 310 hosted by social network server 300. Examples of such received data include instant and/or text messages sent to other members of the social network, blog postings, public postings, broadcast messages, hyperlinks, social network metadata and the like. Thus social network data repository 310 provides storage for a wide variety of social network content generated via interaction between social network subscribers 100 and social network server 300.

Still referring to the example embodiment illustrated in FIG. 1A, a sentiment analysis server 400 is configured to selectively extract, filter and analyze social network content stored in social network data repository 310. Sentiment analysis server 400 includes one or more modules configured to implement certain of the functionalities disclosed herein, and optionally further includes hardware configured to enable such implementation. In such embodiments, this hardware may include, but is not limited to a processor 410, a memory 420, an operating system 430 and a communications adaptor 440. Processor 410 can be any suitable processor, and may include one or more coprocessors or controllers, such as an audio processor or a graphics processing unit, to assist in processing operations of sentiment analysis server 400. Memory 420 can be implemented using any suitable type of digital storage, such as one or more of a disk drive, a universal serial bus (USB) drive, flash memory and/or random access memory. Operating system 430 may comprise any suitable operating system, such as Google Android (Google Inc., Mountain View, Calif.), Microsoft Windows (Microsoft Corp., Redmond, Wash.), or Apple OS X (Apple Inc., Cupertino, Calif.). As will be appreciated in light of this disclosure, the techniques provided herein can be implemented without regard to the particular operating system provided in conjunction with sentiment analysis server 400, and therefore may also be implemented using any suitable existing or subsequently-developed platform. Communications adaptor 440 can be any suitable network chip or chipset which allows for wired and/or wireless communication with social network server 300 and the other components described herein. A bus and/or interconnect 470 may also be provided to allow for inter- and intra-device communications using, for example, communications adaptor 440.

In certain embodiments sentiment analysis server 400 includes a content filter 450 configured to analyze the social network content received from social network server 300 and make predictions with respect to whether individual content items comprise neutral, sentiment bearing, spam or foreign language content. Other content types can be detected in other embodiments, and thus it will be appreciated that the present invention is not intended to be limited to detection and/or filtration of any particular subset of social network content. Predictions with respect to different content types can be used to generate filtered social network content which, in turn, can be provided to a sentiment engine 500 configured to evaluate sentiment expressed therein. For example, in certain embodiments only sentiment bearing content is subjected to sentiment analysis, while in other embodiments both sentiment bearing and neutral content is subjected to sentiment analysis. In some cases a foreign language sentiment engine 500′ is provided, in which case foreign language social network content can be separately subjected to sentiment analysis. In still other cases sentiment analysis server 400 can be configured to provide a raw corpus of unfiltered social network content directly to sentiment engine 500 without prior filtration. Regardless of the particular data that it receives, sentiment engine 500 and/or foreign language sentiment engine 500′ can be configured to evaluate sentiment contained within social network content.

FIG. 1B is a block diagram illustrating selected subcomponents of content filter 450 which can be configured to implement certain of the functionalities disclosed herein. In certain embodiments content filter 450 includes a content parsing module 452 configured to receive unfiltered social network content and parse such content into one or more arrays of words that are formatted in a way that facilities marking of features that are indicative of particular content types. For example, a spam/sentiment feature marker 454 can be configured to identify and mark features in the array of words which are indicative of spam content and/or sentiment bearing content. Likewise, a foreign language feature marker 456 can be configured to identify and mark features in the array of words which are indicative of foreign language content. A probability estimation module 458 can be configured to evaluate the marked features for a particular content item and characterize the content item as being sentiment bearing, neutral, spam or foreign language content.

Referring again to the example embodiment illustrated in FIG. 1A, a sentiment browser 460 can be used as an interface to present the results of the sentiment analysis provided by sentiment engine 500 and/or foreign language sentiment engine 500′. In particular, a social network campaign manager 600 can use the interface provided by sentiment browser 460 to view not only the sentiment analysis results generated by sentiment engine 500 and/or foreign language sentiment engine 500′, but also portions of the underlying social network content that formed the basis for the sentiment analysis. To this end, content filter 450 can be used to restrict the amount of social network content that is provided to sentiment browser 460, thus allowing campaign manager 600 to avoid viewing content that is not of interest, such as spam content, unintelligible foreign language content and/or neutral content. Thus, even where sentiment engine 500 analyzes unfiltered social network content, content filter 450 can still be used to filter the content that is provided to social network campaign manager 600 via sentiment browser 460. Sentiment browser 460 is also optionally capable of receiving configuration settings and/or other operational parameters which can be used to control operation of the various components of sentiment analysis server 400, such as by defining one or more of (a) what content is extracted from social network data repository 310, (b) what content filtering, if any, is performed before the social network content is provided to sentiment engine 500, and (c) how content filter 450 is configured to classify ambiguous social network content, for example by introducing a controlled bias into the content filtration process.

The various embodiments disclosed herein can be implemented in various forms of hardware, software, firmware and/or special purpose processors. For example, in one embodiment a non-transitory computer readable medium has instructions encoded thereon that, when executed by one or more processors, cause one or more of the content filtration and analysis methodologies disclosed herein to be implemented. The instructions can be encoded using any suitable programming language, such as C, C++, object-oriented C, JavaScript, Visual Basic .NET, BASIC, or alternatively, using custom or proprietary instruction sets. The instructions can be provided in the form of one or more computer software applications and/or applets that are tangibly embodied on a memory device, and that can be executed by a computer having any suitable architecture. In one embodiment, the system can be hosted on a given website and implemented, for example, using JavaScript or another suitable browser-based technology. The functionalities disclosed herein can optionally be incorporated into other software applications, such as marketing campaign management applications, or can optionally leverage services provided by other software applications, such as sentiment analysis applications. The computer software applications disclosed herein may include a number of different modules, sub-modules or other components of distinct functionality, and can provide information to, or receive information from, still other components and/or services. These modules can be used, for example, to communicate with input and/or output devices such as a display screen, a touch sensitive surface, a printer and/or any other suitable input/output device. Other components and functionality not reflected in the illustrations will be apparent in light of this disclosure, and it will be appreciated that the claimed invention is not intended to be limited to any particular hardware or software configuration. Thus in other embodiments sentiment analysis server 400 may comprise additional, fewer or alternative subcomponents as compared to those included in the example embodiment illustrated in FIGS. 1A and 1B.

The aforementioned non-transitory computer readable medium may be any suitable medium for storing digital information, such as a hard drive, a server, a flash memory and/or random access memory. In alternative embodiments, the components and/or modules disclosed herein can be implemented with hardware, including gate level logic such as a field-programmable gate array (FPGA), or alternatively, a purpose-built semiconductor such as an application-specific integrated circuit (ASIC). Still other embodiments may be implemented with a microcontroller having a number of input/output ports for receiving and outputting data, and a number of embedded routines for carrying out the various functionalities disclosed herein. It will be apparent that any suitable combination of hardware, software and firmware can be used, and that the present invention is not intended to be limited to any particular system architecture.

Methodology and Data Pipelines

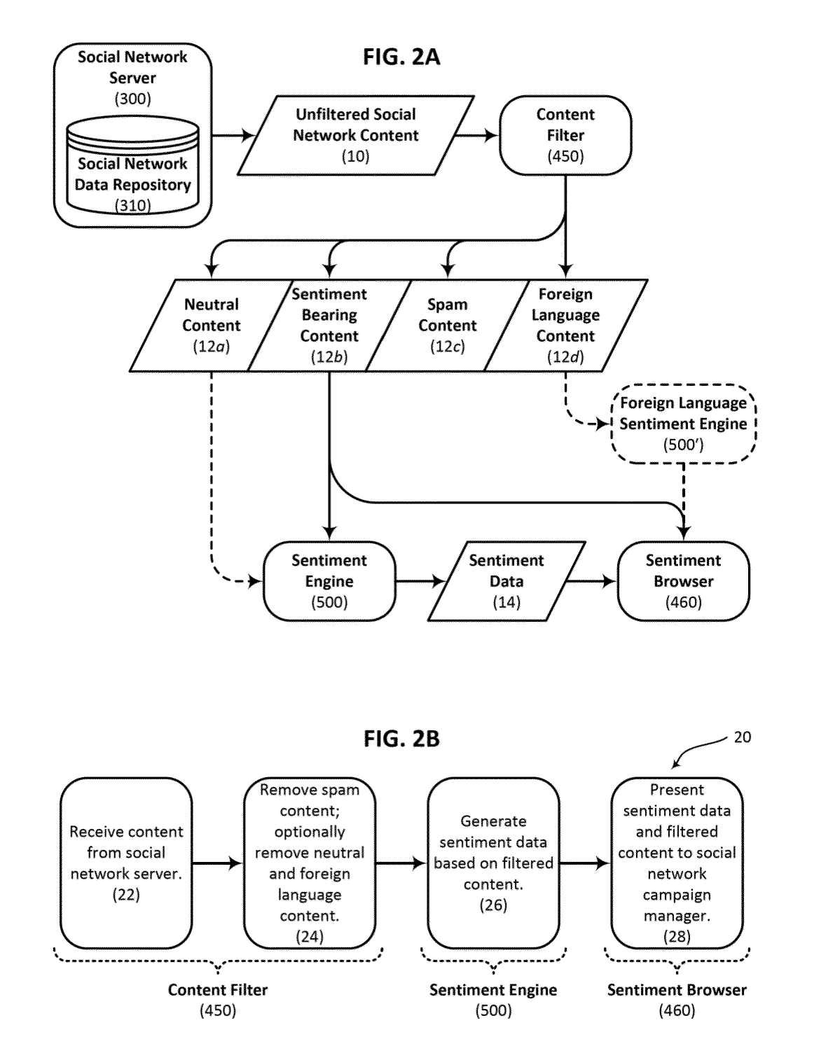

FIG. 2A is a block diagram illustrating data flow amongst selected components of the system of FIG. 1A, wherein social network content is filtered before being subjected to sentiment analysis. FIG. 2B is a flowchart illustrating a method 20 for filtering and analyzing social network content using the data flow of FIG. 2A. As can be seen, this method 20 includes a number of phases and sub-processes, the sequence of which may vary from one embodiment to another. However, when considered in the aggregate, these phases and sub-processes form a complete social network content filtration and analysis process that is responsive to user commands in accordance with certain of the embodiments disclosed herein. These methodologies can be implemented, for example, using the system architecture illustrated in FIGS. 1A and 1B and described herein. However other system architectures can be used in other embodiments, as will be apparent in light of this disclosure. To this end, the correlation of the various data pipelines and functions shown in FIGS. 2A and 2B to the specific components illustrated in FIGS. 1A and 1B is not intended to imply any structural and/or use limitations. Rather, other embodiments may include, for example, varying degrees of integration where multiple functionalities are effectively performed by one system. For example, in an alternative embodiment a single module can be used to perform spam, sentiment bearing and foreign language content marking Or, in another alternative embodiment, functionality described herein as being associated with a separate sentiment engine 500 can instead be integrated into sentiment analysis server 400. Thus other embodiments may have fewer or more modules depending on the granularity of implementation. Numerous variations and alternative configurations will be apparent in light of this disclosure.

As illustrated in FIGS. 2A and 2B, method 20 commences with extracting unfiltered social network content 10 from social network data repository 310 and providing such content to content filter 450. Thus content filter 450 is configured to receive unfiltered social network content 10 from social network server 300. See reference numeral 22 in FIG. 2B. Unfiltered social network content 10 may include a plurality of individual content items selected according to certain user-defined or predetermined criteria. For example, in one embodiment all tweets generated during a particular time period that mention a particular brand can be extracted and provided to content filter 450. In another embodiment, all Facebook status updates that originate from a particular geographical region and that mention a particular retailer can be extracted and provided to content filter 450. Other extraction criteria can be used in other embodiments. Upon receiving the extracted content, content filter 450 can be configured to characterize individual content items as comprising neutral content 12a, sentiment bearing content 12b, spam content 12c, or foreign language content 12d. Other content types can be characterized in other embodiments, such a topics of interest as selected by a campaign manager. Characterizing the content items in this way allows a reduced volume of data to be submitted to sentiment engine 500 for sentiment analysis, thereby reducing the monetary and computational processing costs associated with such analysis. Therefore in one embodiment content filter 450 is configured to remove spam content 12c and optionally remove neutral content 12a and foreign language content 12d from the received content 10. See reference numeral 24 in FIG. 2B.

For example, in one embodiment only sentiment bearing content 12b is forwarded to sentiment engine 500 for sentiment analysis, while spam content 12c is not forwarded from content filter 450 for further analysis. Neutral content 12a may optionally be submitted to sentiment engine 500 for sentiment analysis, depending on whether campaign manager 600 wishes to (a) evaluate only sentiment bearing content 12b (in which case neutral content 12a is not of interest and is dismissed), or (b) evaluate sentiment in the context of all relevant social network content (in with case neutral content 12a functions as a baseline from which sentiment can be measured). For example, neutral content 12a may be discarded when campaign manager 600 wishes only to know what sentiment is present in a social network, whereas neutral content 12a may be retained where it is desired to evaluate what proportion of social network content is expressing sentiment (or a particular sentiment type) with respect to a certain brand, product, or the like. Neutral content 12a may be retained or discarded for other reasons in other embodiments, and thus it will be appreciated that the present invention is not intended to be limited to particular handling of neutral content 12a. Foreign language content 12d is optionally forwarded to foreign language sentiment engine 500′ for foreign language sentiment analysis, where such a resource is available.

Sentiment engine 500, and optionally foreign language sentiment engine 500′, can be configured to generate sentiment data 14 that is indicative of sentiment contained within the content submitted for sentiment analysis. See reference numeral 26 in FIG. 2B. For example, sentiment data 14 can provide campaign manager 600 with information regarding whether users of social networks are positively or negatively disposed toward a particular brand or product. A wide variety of existing or subsequently-developed sentiment analysis services can be used to provide the services associated with sentiment engine 500 and generate resulting sentiment data 14. Once sentiment data 14 has been generated, sentiment browser 460 can be used to provide a user interface for presenting both sentiment data 14 as well as the actual filtered social network content to social network campaign manager 600. See reference numeral 28 in FIG. 2B. This allows campaign manager 600 to review not only sentiment data 14, but the filtered social network content that is generated by content filter 450 and that underlies the sentiment analysis, such as a listing of tweets related to the preselected topics of interest. Thus the filtration provided by content filter 450 advantageously prevents or reduces the likelihood that campaign manager 600 will be presented with spam, foreign language and/or neutral content in sentiment browser 460.

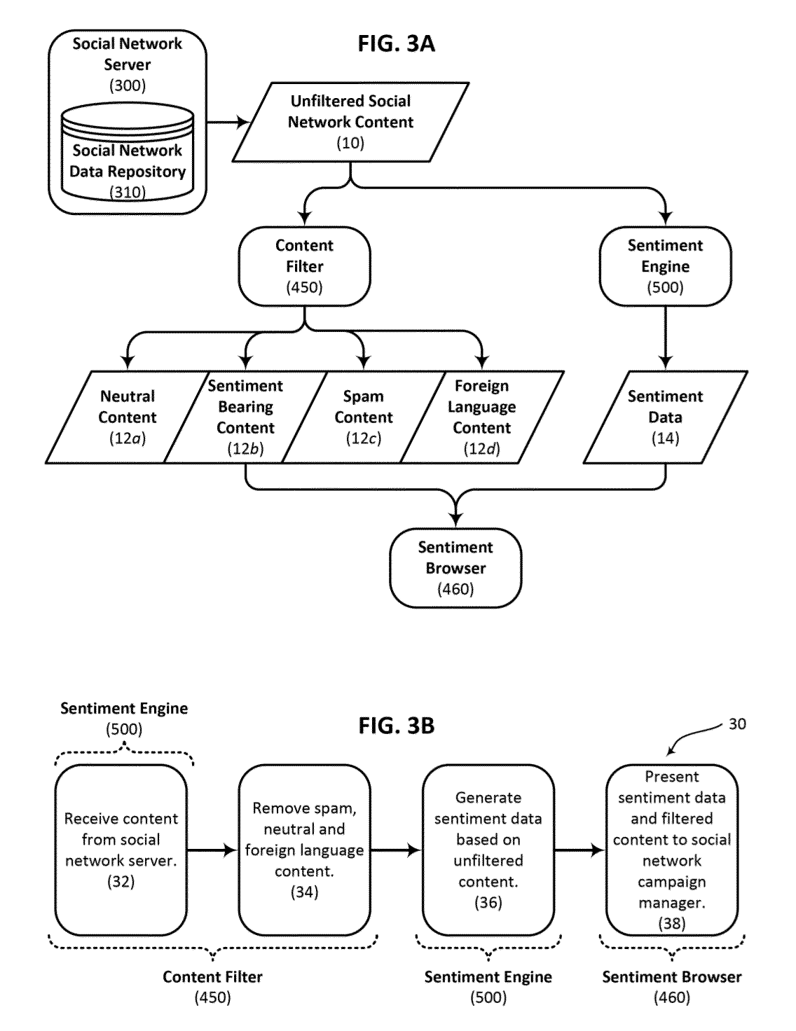

FIGS. 2A and 2B illustrate an example method 20 in which extracted social network content 10 is filtered before being subjected to sentiment analysis. However in other embodiments social network content can additionally or alternatively be filtered independent of the sentiment analysis, as is illustrated in FIGS. 3A and 3B. In particular, FIG. 3A is a block diagram illustrating data flow amongst selected components of the system of FIG. 1A, wherein social network content is not filtered before being subjected to sentiment analysis. FIG. 3B is a flowchart illustrating a method 30 for filtering and analyzing social network content using the data flow of FIG. 3A. Method 30 commences with extracting unfiltered social network content 10 from social network data repository 310 and providing such content to both content filter 450 and sentiment engine 500. Thus content filter 450 and sentiment engine 500 are configured to receive unfiltered social network content 10 from social network server 300. See reference numeral 32 in FIG. 3B. Upon receiving the extracted content, content filter can be configured to characterize individual content items as comprising neutral content 12a, sentiment bearing content 12b, spam content 12c, or foreign language content 12d. Therefore in one embodiment content filter 450 is configured to remove neutral content 12a, spam content 12c and foreign language content 12d from the received content 10. See reference numeral 34 in FIG. 3B.

Meanwhile, sentiment engine 500 can be configured to generate sentiment data 14 based on the entire corpus of unfiltered social network content 10. See reference numeral 36 in FIG. 3B. This may be desirable in applications where social network campaign manager 600 wishes to evaluate sentiment in the context of all extracted social network content. For example, such a configuration may be useful where it is desired to evaluate what proportion of extracted social network content is expressing generalized sentiment and/or a particular type of sentiment. However, even where the entire corpus of unfiltered social network content 10 is subjected to sentiment analysis, content filter 450 can still be used to selectively remove neutral content 12a, spam content 12c, and/or foreign language content 12d. Such filtration advantageously prevents or reduces the likelihood that campaign manager 600 will be presented with such content in sentiment browser 460. In particular, even where neutral, spam and/or foreign language content is subjected to sentiment analysis, it is still often considered unhelpful to present such content to campaign manager 600 via sentiment browser 460. Thus once sentiment data 14 is generated, sentiment browser 460 can be used to provide a user interface for presenting both sentiment data 14 as well as filtered sentiment bearing content 12b to social network campaign manager 600. See reference numeral 38 in FIG. 3B.

Whether sentiment analysis server 400 is configured to submit filtered or unfiltered content to sentiment engine 500 can be selected based on the demands of a particular sentiment analysis application. For example, where filtered content is subjected to sentiment analysis, content filter 450 can be biased to retain any content which might possibly be characterized as sentiment bearing content 12b so that such content can be analyzed by sentiment engine 500. Such a configuration will still reduce the volume of data submitted for sentiment analysis, for example by removing spam content 12c and unintelligible foreign language content 12d, thereby reducing analysis costs and processing time. On the other hand, where unfiltered content is subjected to sentiment analysis, content filter 450 can be biased to remove any content which might possibly be characterized as being not of interest to social network campaign manager 600. Such removed content is sometimes referred to as “noisy” content. In this case, retaining only that content which can confidently be characterized as sentiment bearing content 12b reduces the likelihood that campaign manager 600 will be presented with noisy content and thus facilitates a better sentiment browsing experience using sentiment browser 460. While it is unnecessary to provide separately filtered content to sentiment engine 500 and to sentiment browser 460, such a configuration may be desirable in certain applications.

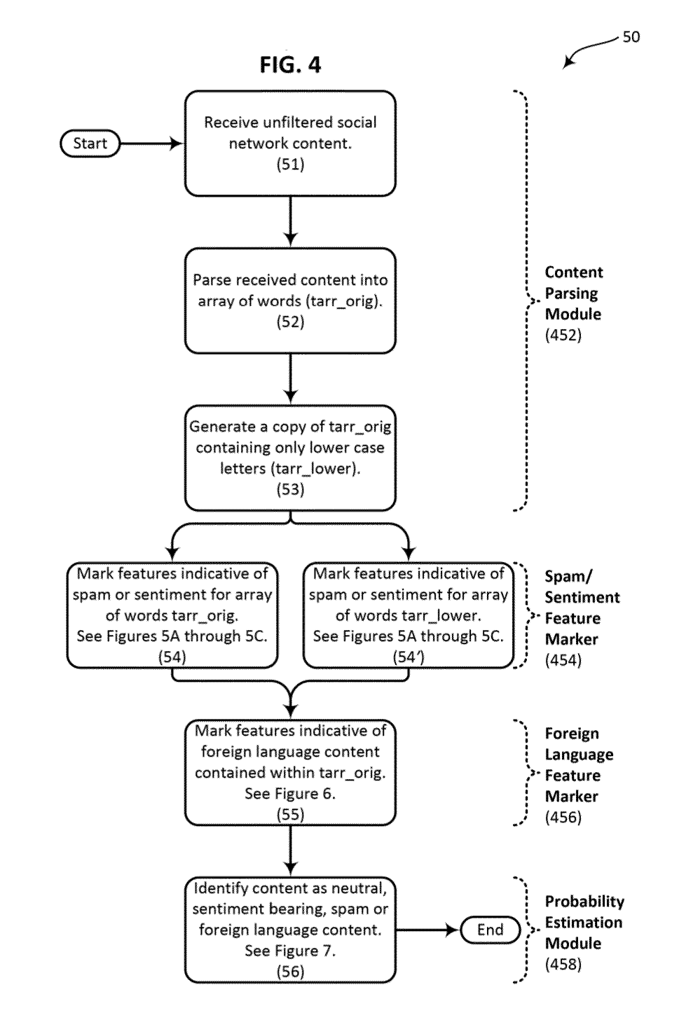

FIG. 4 is a flowchart illustrating a method 50 for characterizing social network content as being neutral, sentiment bearing, spam or foreign language content. In general, method 50 can be implemented using two separate machine learning systems that allow individual content items to be characterized with improved accuracy. For example, a naïve Bayes classifier can initially be trained to consider a plurality of content features to determine which features are indicative of certain content types. For example, it can be determined that a high proportion of misspelled words can be indicative of foreign language content. After relevant features are identified, a SVM learning model can then be used to make predictions with respect to how individual content items are best characterized based on the marked features in each content item. In training the SVM learning model, certain features may be masked based on the prior evaluation of which features are relevant to which content types. In particular, masking the appropriate features improves the accuracy of the SVM learning model in characterizing individual content items. Selective feature masking can also be used to bias the filter toward detection of sentiment bearing content or spam content. Use of multiple machine learning systems provides content filter 450 with a dynamic nature which is particularly useful since spammers often change their terminology, social users have a continually evolving vocabulary used to express profanity, and new users periodically post content using new languages and/or dialects.

Method 50 commences with extracting unfiltered social network content 10 from social network data repository 310 and providing such content to content filter 450. This may occur regardless of whether or not unfiltered content 10 is simultaneously provided to sentiment engine 500 for sentiment analysis, as illustrated in FIGS. 3A and 2A, respectively. Thus content filter 450 is configured to receive unfiltered social network content 10 from social network server 300. See reference numeral 51 in FIG. 4. The unfiltered content 10 can then be parsed into a first array of words which will be referred to herein as tarr_orig. See reference numeral 52 in FIG. 4. A copy of tarr_orig that contains only lower case letters can then be generated; this modified array of words will be referred to herein as tarr_lower. See reference numeral 53 in FIG. 4. Text arrays tarr_orig and tarr_lower will be collectively referred to herein as “the text arrays”. In such embodiments receipt of unfiltered content 10 and generation of the text arrays can be performed by content parsing module 452.

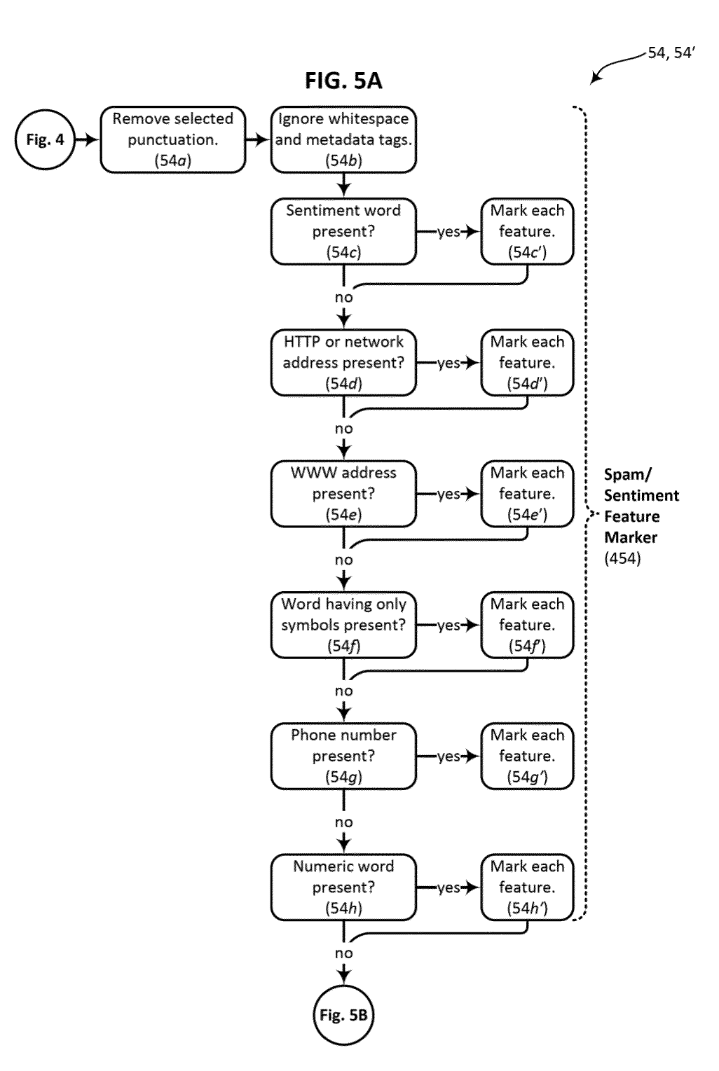

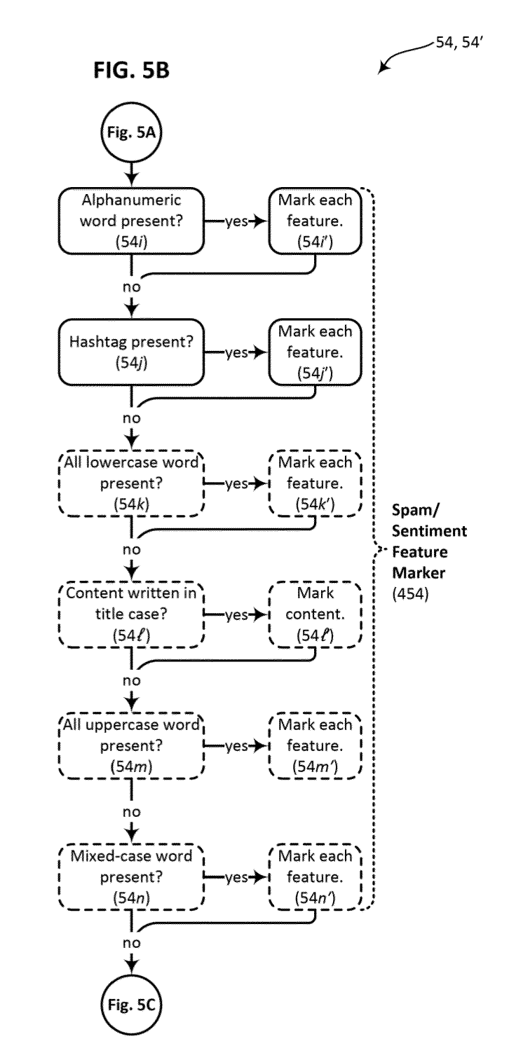

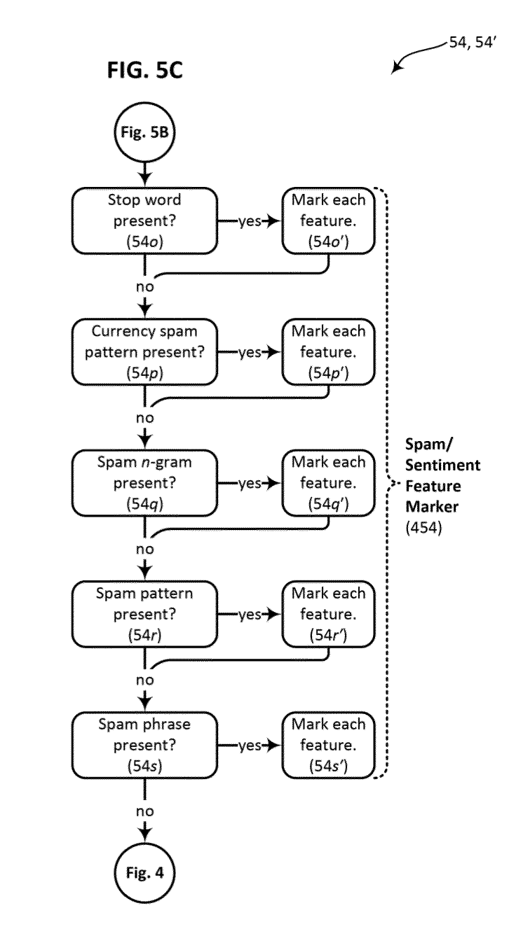

After unfiltered content 10 is parsed into the text arrays, spam/sentiment feature marker 454 can be used to mark features that are indicative of spam or sentiment in the text arrays. See reference numerals 54 and 54′ in FIG. 4. As used herein, the concept of “marking” or “tagging” features refers to the process of determining whether certain features are present in a given content item, and then marking the item as containing such features. Thus a given content item may include several different marked features or may not include any marked features. FIGS. 5A through 5C illustrate an example method for marking such features. The various features that are marked using the example embodiments described herein are disclosed for purposes of illustration only. Fewer, additional or alternative features may be marked in other embodiments, and the order in which features are marked may be modified as well. For example, certain of the features illustrated as being marked in FIGS. 5A through 5C can be considered superfluous or optional, such as features relating to capital letter detection as applied to text array tarr_lower. Likewise, in a modified embodiment the feature marking method illustrated in FIGS. 5A through 5C may be applied to only one of the text arrays. It will thus be appreciated that the present invention is not intended to be limited to marking the specific features disclosed herein.

As illustrated in FIG. 5A, an example feature marking technique commences with removing selected punctuation symbols from the text arrays. See reference numeral 54a in FIG. 5A. Punctuation symbols which may be removed include forward slash, backslash, double quotation mark, single quotation mark, period, exclamation point, question mark, comma, colon, square brackets, parenthesis and hyphen. Fewer, additional or alternative symbols may be removed in other embodiments. In addition, certain whitespace and social network metadata can optionally be ignored or deleted. See reference numeral 54b in FIG. 5A. Examples of whitespace data may include tab or line break codes; examples of social network metadata may include embedded tags that indicate the time, geographical location or other information associated with the content that is not relevant to sentiment evaluation. In addition, tags which are known to be specific to certain social network platforms may be removed as well. Examples of such platform-specific metadata include the @ “reply to” prefix and the RT “re-tweet” indicator, all of which are associated with Twitter. Removal of certain punctuation, whitespace and metadata can enhance the accuracy of subsequent feature marking and sentiment analysis operations.

In certain embodiments the presence of sentiment words in the text arrays is detected and marked as appropriate. See reference numerals 54c and 54c′ in FIG. 5A. Sentiment words are indicative of sentiment, positive or negative, and can be identified by reference to a master lexicon of such words that is optionally periodically or otherwise dynamically updated to include or exclude certain words. Examples of sentiment words include “excellent”, “terrible”, “spectacular” and “horrendous”. The presence of sentiment words in a given content item can be a strong indicator that the content item is sentiment bearing.

In certain embodiments the presence of a hypertext transfer protocol (HTTP) or other network addresses in the text arrays is detected and marked as appropriate. See reference numerals 54d and 54d′ in FIG. 5A. Similarly, the presence of World Wide Web (WWW) addresses in the text arrays can be detected and marked as appropriate as well. See reference numerals 54e and 54e′ in FIG. 5A. HTTP, WWW and other network addresses provide links, active or inactive, to other networked locations where additional content may be accessed. Such links can be detected, for example, by the presence of indicators such as “http:\\”, “www.” or other network address prefixes. The presence of such links in a given content item can be an indicator that the content item is spam content since distributors of spam content often include such links in their messages.

In certain embodiments the presence of “words” comprised only of one or more symbols is detected and marked as appropriate. See reference numerals 54f and 54f′ in FIG. 5A. The presence of phone numbers can also be detected and marked as appropriate. See reference numerals 54g and 54g′ in FIG. 5A. The presence of other “words” comprised only of numbers can also be detected and marked as appropriate. See reference numerals 54h and 54h′ in FIG. 5A. The presence of alphanumeric “words” such as “peer2peer” or “3bman” can also be detected and marked as appropriate. See reference numerals 54i and 54i′ in FIG. 5B. The presence of hash tags such as #baseball or #politics can also be detected and marked as appropriate. See reference numerals 54j and 54j′ in FIG. 5B. Hash tags are words or n-grams prefixed with the symbol #, and are frequently used in certain social network applications to provide a means of grouping content according to common subject matter.

In certain embodiments one or more of a variety of different case-sensitive features may be marked. Such case sensitive may be marked only with respect to the text array tarr_orig that retains both uppercase and lowercase letters. For example, in certain embodiments the presence of all lowercase words can be detected and marked as appropriate. See reference numerals 54k and 54k′ in FIG. 5B. The presence of content written in title case, wherein the first letters of certain words are capitalized, can be detected and marked. See reference numerals 54l and 54l′ in FIG. 5B. The presence of all uppercase words can also be detected and marked as appropriate. See reference numerals 54m and 54m′ in FIG. 5B. The presence of mixed-case words, such as a word having only the first letter or an intermediate letter capitalized, can also be detected and marked as appropriate. Such capitalization patterns can be useful in distinguishing sentiment bearing content from spam content.

In certain embodiments the presence of stop words in the text arrays is detected and marked as appropriate. See reference numerals 54o and 54o′ in FIG. 5C. Stop words are common functional words such as “the”, “is”, “at”, “which” and “on” which are frequently removed as part of natural language processing operations. Stop words may be identified by reference to a master list of such words that is optionally periodically or otherwise dynamically updated to include or exclude certain words. The presence of stop words in a given content item can be a strong indicator that the item is sentiment bearing.

In certain embodiments the presence of currency-based spam patterns is detected and marked as appropriate. See reference numerals 54p and 54p′ in FIG. 5C. Currency-based spam patterns are associated with representations of monetary figures that are observed to be frequently associated with spam content. They can be identified by reference to a master index listing such patterns that is optionally periodically or otherwise dynamically updated to include or exclude certain patterns. Examples of currency-based spam patterns include text strings such as “$9.99”, “990” and “$$$”. The presence of currency-based spam patterns in a given content item can be a strong indicator that the content item is spam.

In certain embodiments the presence of spam n-grams in the text arrays is detected and marked as appropriate. See reference numerals 54q and 54q′ in FIG. 5C. Spam n-grams are words and/or phrases which are observed to be frequently associated with spam content. They can be identified by reference to a master lexicon of such n-grams that is optionally periodically or otherwise dynamically updated to include or exclude certain words. Examples of spam n-grams include “earn more”, “free offer” and “free pics”. The presence of spam n-grams in a given content item can be a strong indicator that the content item is spam.

In certain embodiments the presence of spam patterns is detected and marked as appropriate. See reference numerals 54r and 54r′ in FIG. 5C. Spam patterns are produced as a result of tactics used by spam distributors to draw attention to their content and/or to evade other spam detection methodologies. Such patterns can be identified by reference to a master index listing such patterns that is optionally periodically or otherwise dynamically updated to include or exclude certain patterns. One example of such a spam pattern is the inclusion of a space between individual letters of a phrase that might otherwise be easily detectable as spam, such as “free offer”. Another example is preceding a network address with a known term, such as “pic http:\\example.com”, “watch http:\\example.com”, or “live http:\\www.example.com”. The presence of spam patterns in a given content item can be a strong indicator that the content item is spam.

In certain embodiments the presence of spam phrases is detected and marked as appropriate. See reference numerals 54s and 54s′ in FIG. 5C. Spam phrases are variable phrases that are observed to be frequently associated with spam content. They can be identified by reference to a master dictionary of such phrases that is optionally periodically or otherwise dynamically updated to include or exclude certain words. Example of spam phrases include “up to 20% off”, “save up to 90%”, “buy prescription Rx online” and “great prescription Rx offer”. Spam phrases may have other terms incorporated therein, such as “20%” or “prescription Rx”, which by themselves might be neutral with respect to a content prediction, but when placed in the context of phrases such as “save up to . . . ” or “buy . . . online” are strongly indicative of spam content.

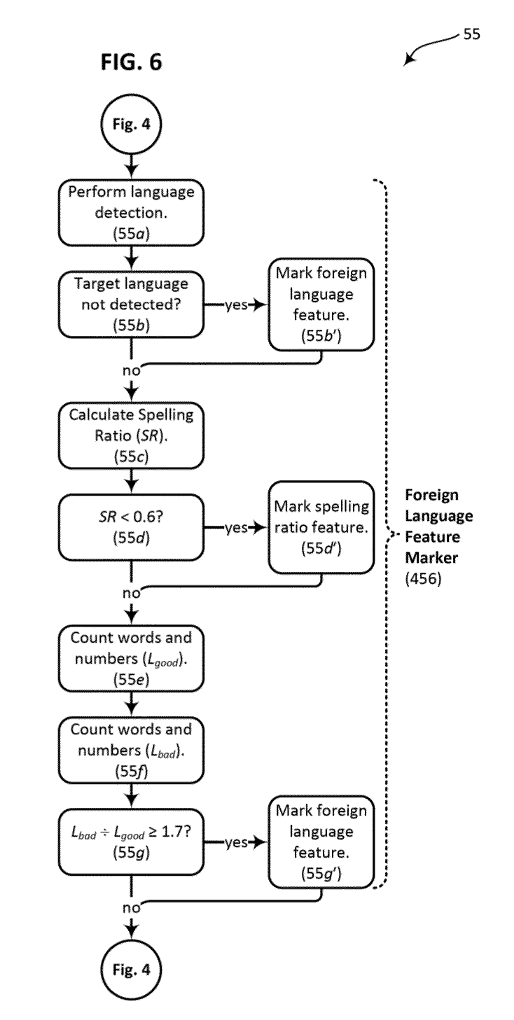

As described herein, the features marked using the example method illustrated in FIGS. 5A through 5C are primarily configured to distinguish between spam and sentiment bearing content items. While certain of these features may also suggest the presence of foreign language content, other feature marking techniques may be more suitable for detecting such content. For example, as provided by method 50 illustrated in FIG. 4, foreign language feature marker 456 can be specifically configured to mark features indicative of foreign language content contained within text array tarr_orig. See reference numeral 55 in FIG. 4. FIG. 6 illustrates an example embodiment of method 55. Method 55 optionally commences with performing a language detection technique. See reference numeral 55a in FIG. 6. A variety of existing or subsequently-developed language detection services and/or application programming interfaces (APIs) may be invoked in this regard, and such services may be provided by external modules that are coupled to sentiment analysis server 400. Where the language detection technique results in a target language not being detected, a foreign language feature can be marked with respect to the analyzed content item. See reference numerals 55b and 55b′ in FIG. 6.

Still referring to the example foreign language marking method 55 illustrated in FIG. 6, another technique for detecting the presence of foreign language content involves the calculation of a spelling ratio. See reference numeral 55c in FIG. 6. In such embodiments, the spelling ratio SR is defined as

$$SR = \frac{\begin{matrix}number of correctly spelled words \\ in content item\end{matrix} }{total number of words in content item} . \qquad ( Equation 1 )$$

In this case, the number of correctly spelled words in the content item can be determined with respect to a target (non-foreign) language. Where the spelling ratio SR is less than a predetermined threshold value, a spelling ratio feature can be marked with respect to the analyzed content item. See reference numerals 55d and 55d′ in FIG. 6. In one embodiment the predetermined threshold value for a spelling ratio that is indicative of the presence of foreign language content is 0.6, although other values such as 0.1, 0.2, 0.3, 0.4, 0.5, 0.55, 0.65, 0.7, 0.8 and 0.9 may be used in other embodiments.

Yet another technique for detecting the presence of foreign language content involves counting words contained within the text array tarr_orig. Words contained within a given content item are classified into one of two categories: “good” and “bad”. Words that are formed from a target alphabet and/or numbers are classified as “good”, while all other words are classified as “bad”. This allows noisy data such as words containing only symbols or words formed using a foreign language character set to be classified as bad. The number of words classified as “good” can be tallied and designated as a parameter “good_length” or L_{good}, while the number of words classified as “bad” can be tallied and designed as a parameter “bad_length” or L_{bad}. See reference numerals 55e and 55f in FIG. 6. A ratio L_{bad}÷L_{good} can then be calculated and, if greater than or equal to a predetermined threshold value, a foreign language feature can be marked with respect to the analyzed content item. See reference numerals 55g and 55g′ in FIG. 6. In one embodiment the predetermined threshold value for the ratio L_{bad}÷L_{good} that is indicative of the presence of foreign language content is 1.7, although other values such as 1.1, 1.2, 1.3, 1.4, 1.5, 1.6, 1.65, 1.75, 1.8, 1.9 and 2.0 may be used in other embodiments.

It will be appreciated that the example foreign language feature marking methodology 55 illustrated in FIG. 6 actually contains three separate tests for evaluating the presence of markers that are indicative of foreign language content. These three separate tests are based on (a) one or more language detection algorithms, (b) a spelling ratio, and (c) a ratio of “bad” words to “good” words. In modified embodiments additional, fewer or alternative tests may be used to evaluate the presence of foreign language markers. For example, in one embodiment only the tests based on the spelling ratio and the bad:good word ratio may be used. Other modifications may be used in other embodiments. Thus it will be appreciated that the present invention is not intended to be limited to any single test or collection of tests which may be used to evaluate the presence of markers that are indicative of foreign language content.

For example, in a modified embodiment detection of a combination of certain features related to foreign language content can result in a high-confidence determination that the content under analysis is foreign language content. In such embodiments other feature marking may be bypassed as a result of such a determination, thereby eliminating unnecessary analysis for detection of spam and/or sentiment bearing content and streamlining the subsequent processing of the detected foreign language content. For example, in one embodiment if both a language detection technique and analysis of the spelling ratio indicate that a particular content item is foreign language content, then the content item can be so classified and subsequent feature marking can be terminated. In other embodiments a similar early-termination procedure can be implemented if any one of the three tests illustrated in FIG. 6 indicate that a particular content item is foreign language content. The particular thresholds established to trigger early termination of feature marking, if any, can be based on a desired confidence level in the foreign language content determination, as selected by social network campaign manager 600.

When taken together, the methodologies illustrated in FIGS. 5A through 5C and FIG. 6 can be used to mark a variety of different features which are indicative of spam, sentiment bearing and/or foreign language content. A given content item may include several different marked features or may not include any marked features. Execution of methodologies such as illustrated in FIG. 5A through 5C and FIG. 6 result in the generation of feature vectors for the unfiltered social network content 10 extracted from social network data repository 310. A feature vector is a representation of the various marked features for a particular content item. Using a naïve Bayes probability distribution, it is possible to ascribe a weighting and/or a ranking to the various detected features. In particular, Baysean probabilities can be used to determine which of the various marked features are most highly indicative of each of sentiment bearing content, spam content and foreign language content. For example, Table A lists certain features and their relative ranking with respect to various content types, wherein lower a ranking indicates a higher correlation to a particular content type and vice-versa. Such rankings can be determined using a naïve Bayes probability distribution.

TABLE A
Example features with rankings indicating relevance for
sentiment bearing, spam and foreign language content.

| | Marking of this | | | |
|---|---|---|---|---|
| | feature is illus- | Senti- | | Foreign |
| | trated at (Figure - | ment | Spam | Language |
| Feature | Reference Numeral) | Rank | Rank | Rank |
| sentiment word | 5A - 54c, 54c′ | 1 | 11 | 7 |
| HTTP link | 5A - 54d, 54d′ | 3 | 5 | 3 |
| WWW address | 5A - 54e, 54e′ | 2 | 6 | 4 |
| symbols-only word | 5A - 54f, 54f′ | 9 | 18 | 17 |
| phone number | 5A - 54g, 54g′ | 14 | 10 | 13 |
| numeric-only word | 5A - 54h, 54h′ | 8 | 12 | 16 |
| alphanumeric word | 5B - 54i, 54i′ | 1 | 15 | 18 |
| hashtag | 5B - 54j, 54j′ | 5 | 7 | 5 |
| lowercase-only word | 5B - 54k, 54k′ | 4 | 13 | 8 |
| title case content | 5B - 54l, 54l′ | 6 | 8 | 19 |
| uppercase-only word | 5B - 54m, 54m′ | 12 | 14 | 14 |
| mixed-case word | 5B - 54n, 54n′ | 5 | 16 | 15 |
| stop word | 5C - 54o, 54o′ | 2 | 6 | 4 |
| currency spam pattern | 5C - 54p, 54p′ | 10 | 3 | 11 |
| spam n-gram | 5C - 54q, 54q′ | 8 | 1 | 9 |
| spam pattern | 5C - 54r, 54r′ | 13 | 2 | 10 |
| spam phrase | 5C - 54s, 54s′ | 11 | 4 | 12 |
| foreign language detect | 6 -55b′, 55g′ | 15 | 19 | 2 |
| spelling ratio | 6 -55d′ | 16 | 17 | 1 |

The rankings provided in Table A can be used to identify those features which are most highly indicative of certain content types. For example, the presence of features that are marked as being sentiment words is highly indicative of sentiment bearing content. Likewise, the presence of features marked as being spam n-grams, spam patterns and currency spam patterns is highly indicative of spam content. And the presence of content marked according to one of the foreign language detection tests illustrated in FIG. 6 is highly indicative of foreign language content. It will be appreciated that the rankings indicated in Table A represent the results of a particular naïve Bayes probability distribution based on a corpus of training content having known characteristics. Periodically or continually retraining the machine learning system to update the rankings of the various marked features enables the system to respond to changing content usage patterns over time.

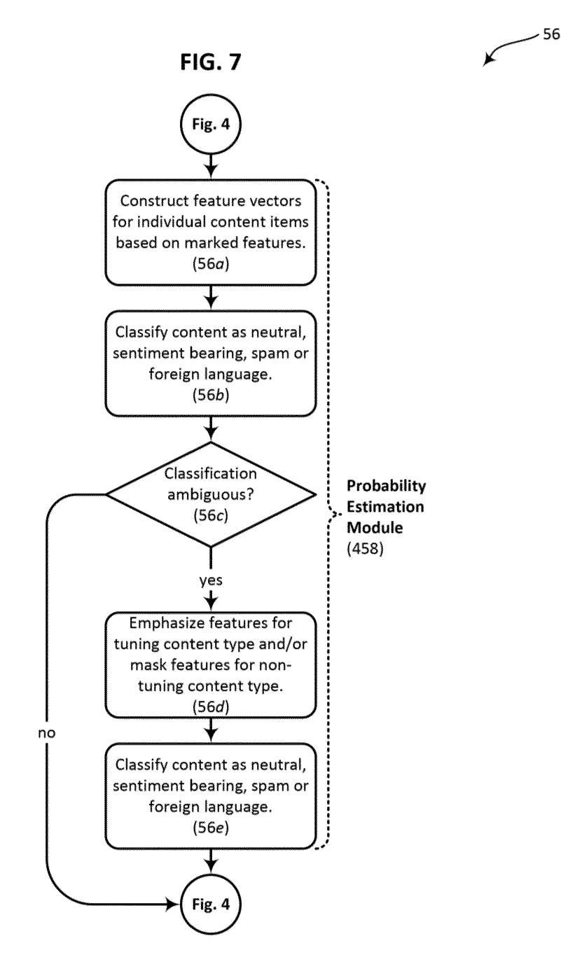

As illustrated in FIG. 4, after features indicative of the various content types to be filtered have been marked, content can be identified as neutral, sentiment bearing or foreign language content based on such feature marking See reference numeral 56 in FIG. 4. In particular, FIG. 7 illustrates a method 56 for classifying social network content based on the feature-marking methodologies described herein using probability estimation module 458. Method 56 commences with constructing feature vectors for individual content items based on the previously marked content features. See reference numeral 56a in FIG. 7. An individual content item may be associated with several different marked features, or in some cases, may not be associated with any marked features. Based on the generated feature vectors, content may be classified as neutral, sentiment bearing, spam or foreign language content. See reference numeral 56b in FIG. 7. For example, based on the example rankings provided in Table A, a content item having only spam n-gram, spam pattern and currency spam pattern features marked can be predicted to be spam content with a relatively high degree of confidence. Likewise a content item having only foreign language detection and spelling ratio features marked can be predicted to be foreign language content with a relatively high degree of confidence. Where the nature of a particular content item can be predicted with a sufficiently high degree of confidence, the content item can be discarded, processed by sentiment engine 500 or forwarded to sentiment browser 460 as appropriate. See reference numeral 56c in FIG. 7.

However in some cases the nature of the content item may be ambiguous or it may not be possible to make a prediction with respect to the nature of the content item with a sufficiently high degree of confidence. Ambiguity or a lower prediction confidence level may arise where the marked features conflict or otherwise do not lead to a clear conclusion with respect to the nature of a particular content item. In one embodiment, ambiguous content items can simply be classified with a lower confidence level, meaning that content filter 450 may occasionally misclassify certain content items. However in an alternative embodiment content filter 450 can optionally be manipulated so as to bias the content characterization process toward either (a) retaining any data that might possibly contain sentiment, in which case ambiguous content is characterized as sentiment bearing content, or (b) discarding any data that might possibly contain irrelevant data, in which case ambiguous content is characterized as spam content. A selective bias can be introduced by emphasizing features associated with a tuning content type and/or masking features associated with a non-tuning content type. See reference numeral 56d in FIG. 7. The feature vectors can then be reevaluated, and the content item may be classified as neutral, sentiment bearing, spam or foreign language content. See reference numeral 56e in FIG. 7.

For example, where social network campaign manager 600 wishes to bias the content characterization process toward detection of sentiment bearing content, features associated with spam content—such as the presence of spam n-grams and spam patterns—can be masked. This will cause the masked features to be ignored, and will thus reduce ambiguity and/or allow a content type prediction to be made with a higher degree of confidence. It will also tend to bias the content filtration process toward retaining any content which might possibly contain sentiment. Likewise, where social network campaign manager 600 wishes to bias the content characterization process toward detection of spam content, features associated with sentiment bearing content—such as the presence of sentiment words—can be masked. This will cause the masked features to be ignored, and will likewise reduce ambiguity and/or allow a content type prediction to be made with a higher degree of confidence. It will also tend to bias the content filtration process toward discarding any content which might possibly be spam content.

In certain embodiments how content filter 450 is biased may depend on whether content filter 450 is filtering content for the purpose of (a) reducing the amount of content provided to sentiment engine 500 for sentiment analysis (as illustrated in FIG. 2A), or (b) reducing the amount of content provided to sentiment browser 460 for review by campaign manager 600 (as illustrated in FIG. 3A). For example, where the filtered content is being provided to sentiment engine 500, ambiguous content can be biased toward detection of sentiment or spam by selectively masking certain features as described herein. Ambiguous content may alternatively be unbiased, meaning that it is either classified as sentiment bearing content or spam content with a lower degree of certainty, or is simply classified as neutral content. On the other hand, where the filtered content is being provided to sentiment browser 460, it is generally desired to bias ambiguous content toward removal of any noisy or neutral content so as to avoid burdening campaign manager 600 with reviewing large quantities of uninteresting content. These various selective biasing configurations are summarized in Table B.

TABLE B
Example configurations for selectively biasing content filter
based on subsequent processing of filtered content.

| | Ambiguous content | Content filter retains |
|---|---|---|
| Filtered content | is biased toward | and forwards for |
| is provided to | detection of | subsequent processing |
| sentiment engine | sentiment bearing | only sentiment bearing content |
| | content | |
| sentiment engine | (not biased) | sentiment bearing and neutral |
| | | content |
| sentiment engine | spam content | sentiment bearing and neutral |
| | | content |
| sentiment browser | spam content | only sentiment bearing content |

Thus in certain embodiments content filtration method 50 illustrated in FIG. 4 uses two separate machine learning systems that work together to allow individual content items to be characterized with improved accuracy. In particular, a naïve Bayes classifier is initially trained to consider a plurality of content features to determine which features are indicative of certain content types. Once such features are marked with respect to a particular content item, a SVM learning model can be used to make predictions with respect to how individual content items are best characterized based on the marked features in each content item. Selectively masking certain features may also be used to introduce a controlled bias to the filter, thereby allowing social network campaign manager 600 to, for example, retain any content which might possibly contain sentiment, or discard any content which might possibly contain spam. The systems disclosed herein have been able to characterize social network content with significantly higher accuracy than can be achieved using conventional filtration techniques based on, for example, a bag-of-words model.

### CONCLUSION

Numerous variations and configurations will be apparent in light of this disclosure. For instance one example embodiment of the present invention provides a computer-implemented content filtration method for analyzing and filtering content generated via an online social network. The method comprises receiving a plurality of social network content items from a social network server. Each of the plurality of content items can be characterized as one of a plurality of content types. The method further comprises evaluating a selected one of the plurality of content items for applicability of a plurality of features. The method further comprises generating a feature vector corresponding to the selected content item. The feature vector provides a representation of a subset of the plurality of features which are evaluated as being applicable to the selected content item. The method further comprises selectively masking a feature included in the subset. The masked feature is selected based on a correlation between the masked feature and a selected content type that is to be excluded through the content filtration method. The method further comprises characterizing the selected content item as one of the plurality of content types based on unmasked features in the feature vector. In some cases (a) receiving the plurality of social network content items from the social network server comprises selectively extracting the plurality of social network content items from a social network data repository hosted by the social network server; and (b) the selective extraction is performed based on a user defined search criterion. In some cases the plurality of features includes presence of a sentiment word and presence of a spam pattern. In some cases the correlation between the masked feature and the selected content type that is to be excluded is based on a naïve Bayes probability distribution. In some cases the selected content type is selected from the group consisting of spam content and sentiment bearing content. In some cases (a) the correlation between the masked feature and the selected content type that is to be excluded is based on a naïve Bayes probability distribution; and (b) the selected content item is further characterized based on a prediction generated by a support vector machine learning model. In some cases (a) the masked feature is a spelling ratio SR defined by Equation 1, and (b) the selected content type is foreign language content. In some cases (a) the masked feature is a spelling ratio SR that is less than 0.6 and that is defined by Equation 1, and (b) the selected content type is foreign language content. In some cases the masked feature is correlated with spam content and the selected content item is characterized as sentiment bearing content.

Another example embodiment of the present invention provides a computer-implemented method for evaluating sentiment in content generated via an online social network. The method comprises receiving, from a social network server, a corpus of social network content that comprises a plurality of social network content items. The method further comprises filtering the received corpus of social network content to extract a plurality of sentiment bearing content items. The method further comprises submitting the extracted sentiment bearing content items to both a sentiment engine and a sentiment browser. The sentiment browser is configured to receive results of a sentiment analysis that is performed on the sentiment bearing content items by the sentiment engine. In some cases the received corpus of social network content is defined by a common characteristic selected from the group consisting of a keyword, a posting time and a posting geographical region. In some cases filtering the received corpus of social network content to extract the plurality of sentiment bearing content items further comprises applying multiple machine learning systems to the social network content items. In some cases the plurality of social network content items comprises a plurality of Twitter tweets. In some cases (a) the received corpus of social network content is further filtered to extract a plurality of neutral content items; and (b) the neutral content items are submitted to the sentiment engine with the sentiment bearing content items, but are not submitted to the sentiment browser. In some cases the method further comprises (a) filtering the received corpus of social network content to extract a foreign language content item; and (b) submitting the foreign language content item to a foreign language sentiment engine, wherein the sentiment browser is further configured to receive results of a foreign language sentiment analysis that is performed on the foreign language content item. In some cases the method further comprises displaying the results of the sentiment analysis and at least a portion of the extracted sentiment bearing content items in a user interface generated by the sentiment browser.

Another example embodiment of the present invention provides asocial network content filtration system that comprises a content parsing module configured to receive a plurality of social network content items from a social network server. Each of the plurality of content items can be correlated with one or more of a plurality of content types. The plurality of content types include a target content type and an excluded content type. The system further comprises a feature marking module configured to generate a feature vector corresponding to a selected content item. The feature vector defines a plurality of features which are evaluated as being applicable to the selected content item. The system further comprises a probability estimation module configured to (a) selectively mask one of the plurality of features based on a correlation between the masked feature and the excluded content type, and (b) characterize the selected content item as being correlated with a particular content type based on unmasked features in the feature vector. The system further comprises a sentiment browser configured to receive content items correlated with the target content type based on characterizations made by the probability estimation module. In some cases the probability estimation module is further configured to selectively mask multiple features based on a correlation between each of the masked multiple features and the excluded content type. In some cases the feature marking module further comprises (a) a spam/sentiment feature marking sub-module configured to mark features which indicate a distinction between spam content and sentiment bearing content; and (b) a foreign language feature marking sub-module configured to mark features indicative of foreign language content. In some cases (a) selectively masking one of the plurality of features is further based on a naïve Bayes probability distribution; and (b) the selected content item is further characterized based on a prediction generated by a support vector machine learning model.

Another example embodiment of the present invention provides a computer program product encoded with instructions that, when executed by one or more processors, causes a content filtration process to be carried out. The process comprises receiving, from a social network server, a plurality of social network content items, The process further comprises filtering the received social network content items to extract a subset of sentiment bearing content items. The process further comprises submitting the plurality of social network content items to a sentiment engine. The process further comprises receiving, from the sentiment engine, sentiment data corresponding to the plurality of social network content items. The process further comprises providing the subset of sentiment bearing content items and the sentiment data to a sentiment browser that is configured to display the sentiment data and at least a portion of the subset of sentiment bearing content items in a user interface. In some cases the process further comprises filtering the received social network content items to remove spam content before submitting the plurality of social network content items to the sentiment engine.

The foregoing description of the embodiments of the present invention has been presented for the purposes of illustration and description. It is not intended to be exhaustive or to limit the invention to the particular disclosed embodiments. Many modifications and variations are possible in light of this disclosure. Thus it is intended that the scope of the invention be limited not be this detailed description, but rather by the claims appended hereto.

What is claimed is:

1. A computer-implemented content filtration method for analyzing and filtering content generated via an online social network, the method comprising:
receiving a plurality of social network content items from a social network server, wherein each of the plurality of content items can be characterized as one of a plurality of content types, the plurality of content types including sentiment bearing social network content and spam content;
evaluating a particular one of the plurality of content items for applicability of a plurality of features;
generating a feature vector corresponding to the particular content item, the feature vector providing a representation of a subset of the plurality of features which are evaluated as being applicable to the particular content item;
selectively masking a feature included in the subset, wherein the masked feature is selected based on a correlation between the masked feature and a selected content type that is to be excluded through the content filtration method; and
characterizing the particular content item as one of the plurality of content types based on unmasked features in the feature vector.

2. The method of claim 1, wherein:
receiving the plurality of social network content items from the social network server comprises selectively extracting the plurality of social network content items from a social network data repository hosted by the social network server; and
the selective extraction is performed based on a user defined search criterion.

3. The method of claim 1, wherein the plurality of features includes presence of a sentiment word and presence of a spam pattern.

4. The method of claim 1, wherein the correlation between the masked feature and the selected content type that is to be excluded is based on a naïve Bayes probability distribution.

5. The method of claim 1, wherein the selected content type is selected from the group consisting of spam content and sentiment bearing content.

6. The method of claim 1, wherein:
the correlation between the masked feature and the selected content type that is to be excluded is based on a naïve Bayes probability distribution; and
the particular content item is further characterized based on a prediction generated by a support vector machine learning model.

7. The method of claim 1, wherein:
the masked feature is a spelling ratio SR defined by
$$SR = \frac{\begin{matrix}number of correctly spelled words \\ in the particular content item\end{matrix} }{total number of words in the particular content item} ;$$
and the selected content type is foreign language content.

8. The method of claim 1, wherein:
the masked feature is a spelling ratio SR that is less than 0.6 and that is defined by
$$SR = \frac{\begin{matrix}number of correctly spelled words \\ in the particular content item\end{matrix} }{total number of words in the particular content item} ;$$
and the selected content type is foreign language content.

9. The method of claim 1, wherein the masked feature is correlated with spam content and the particular content item is characterized as sentiment bearing content.

10. A computer-implemented method for evaluating sentiment in content generated via an online social network, the method comprising:
receiving, from a social network server, a corpus of social network content that comprises a plurality of social network content items;
filtering the received corpus of social network content to extract a plurality of sentiment bearing content items; and
submitting the extracted sentiment bearing content items to both a sentiment engine and a sentiment browser, wherein the sentiment browser is configured to receive results of a sentiment analysis that is performed on the sentiment bearing content items by the sentiment engine.

11. The method of claim 10, wherein the received corpus of social network content is defined by a common characteristic selected from the group consisting of a keyword, a posting time and a posting geographical region.

12. The method of claim 10, wherein filtering the received corpus of social network content to extract the plurality of sentiment bearing content items further comprises applying multiple machine learning systems to the social network content items.

13. The method of claim 10, wherein the plurality of social network content items comprises a plurality of Twitter tweets.

14. The method of claim 10, wherein:
the received corpus of social network content is further filtered to extract a plurality of neutral content items; and
the neutral content items are submitted to the sentiment engine with the sentiment bearing content items, but are not submitted to the sentiment browser.

15. The method of claim 10, further comprising:
filtering the received corpus of social network content to extract a foreign language content item; and
submitting the foreign language content item to a foreign language sentiment engine, wherein the sentiment browser is further configured to receive results of a foreign language sentiment analysis that is performed on the foreign language content item.

16. The method of claim 10, further comprising displaying the results of the sentiment analysis and at least a portion of the extracted sentiment bearing content items in a user interface generated by the sentiment browser.

17. A social network content filtration system comprising:
a content parsing module configured to receive a plurality of social network content items from a social network server, wherein each of the plurality of content items can be correlated with one or more of a plurality of content types, the plurality of content types including sentiment bearing content and spam content;
a feature marking module configured to generate a feature vector corresponding to a particular content item, the feature vector defining a plurality of features which are evaluated as being applicable to the particular content item, wherein the feature marking module is configured to mark features which indicate a distinction between sentiment bearing content and spam content;
a probability estimation module configured to (a) selectively mask one of the plurality of features based on a correlation between the masked feature and spam content, and (b) characterize the particular content item as being correlated with sentiment bearing content based on unmasked features in the feature vector; and
a sentiment browser configured to receive content items correlated with sentiment bearing content based on characterizations made by the probability estimation module.

18. The system of claim 17, wherein the probability estimation module is further configured to selectively mask multiple features based on a correlation between each of the masked multiple features and spam content.

19. The system of claim 17, wherein the feature marking module further comprises a foreign language feature marking sub-module configured to mark features indicative of foreign language content.

20. The system of claim 17, wherein:
selectively masking one of the plurality of features is further based on a naïve Bayes probability distribution; and
the particular content item is further characterized based on a prediction generated by a support vector machine learning model.

21. A computer program product encoded with instructions that, when executed by one or more processors, causes a social network content filtration process to be carried out, the process comprising:
receiving, from a social network server, a plurality of social network content items;
filtering the received social network content items to extract a subset of sentiment bearing content items;
submitting the plurality of social network content items to a sentiment engine;
receiving, from the sentiment engine, sentiment data corresponding to the plurality of social network content items; and
providing the subset of sentiment bearing content items and the sentiment data to a sentiment browser that is configured to display the sentiment data and at least a portion of the subset of sentiment bearing content items in a user interface.

22. The computer program product of claim 21, the process further comprising filtering the received social network content items to remove spam content before submitting the plurality of social network content items to the sentiment engine.
